(19) United States
(12) Patent Application Publication
(10) Pub. No.: US 2021/0334303 A1
(43) Pub. Date: Oct. 28, 2021

(54) DATA SHARING METHOD, DEVICE AND SYSTEM

(71) Applicants: Beijing BOE Art Cloud Technology Co., Ltd., Beijing (CN); BOE TECHNOLOGY GROUP CO., LTD., Beijing (CN)

(72) Inventors: Caixia GUO, Beijing (CN); Fengming HU, Beijing (CN); Bendeng LV, Beijing (CN)

(21) Appl. No.: 16/481,601

(22) PCT Filed: Dec. 3, 2018
(86) PCT No.: PCT/CN2018/118882

§ 371 Date: Jul. 29, 2019

(30) Foreign Application Priority Data
Mar. 22, 2018 (CN) 201810240990.4

(51) Int. Cl. G06F 16/535; G06F 16/538; G06F 1/16; G06F 9/54

(52) U.S. Cl. CPC G06F 16/535; G06F 9/544; G06F 1/163; G06F 16/538

(57) ABSTRACT

A data sharing method includes the steps of establishing an association relationship between an information output device and an associated device; receiving shared data and a sharing manner sent by the associated device; determining a display mode of the information output device based on the sharing manner; and sending the shared data to the information output device to display based on the display mode.

### CROSS REFERENCE TO RELATED APPLICATIONS

The present application is a 35 U.S.C. 371 national stage application of PCT International Application No. PCT/CN2018/118882, filed on Dec. 3, 2018, which claims the benefit of Chinese Patent Application No. 201810240990.4, filed on Mar. 22, 2018, the entire disclosures of which are incorporated herein by reference.

### TECHNICAL FIELD

The present disclosure relates to technical fields of network communication and video display, and in particular, to a data sharing method, device and system.

### BACKGROUND

With the development of economy in China, the problem of aging has become increasingly prominent. Because of the increasing pressure of life, young people have to go to work and cannot accompany the elderly at all times, resulting in an increase in the number of empty nesters (comprising elderly people living alone). According to the data released by the National Committee on Aging, the proportion of empty nesters (comprising elderly people living alone) in urban areas in China has reached 49.7%, and the proportion of empty nesters (comprising elderly people living alone) in large and medium-sized cities is higher and has reached 56.1%. Therefore, in order to prevent accidents caused by lack of timely treatment for empty nesters or elderly people living alone, it is extremely urgent to monitor their physical health in real time and to realize the sharing of monitored data between the relatives. Thus, smart wearable devices (such as smart watches, bracelets, etc.) for monitoring various physiological parameters of human have emerged.

In the related art, a conventional wearable device usually saves real-time detected data in the device or in the terminal APP, and cannot directly track and share data with the family or the doctor. For example, A's father B bought a smart watch, and the detected data can only be saved in the local device (i.e. the smart watch). If A wants to know the recent physical condition of B, it may be necessary for A to download the same APP using a device such as a computer or a mobile phone, and input the same account to synchronize to obtain the physiological data of B; and, during the operation, A may also need to communication with B in real time to complete the synchronization of the account. Therefore, the data sharing operation of the related art wearable device is complicated and cumbersome, and the user cannot be given a good experience.

### SUMMARY

According to an exemplary embodiment of the present disclosure, a data sharing method is provided, comprising following steps:

establishing an association relationship between an information output device and an associated device;

receiving shared data and a sharing manner sent by the associated device;

determining a display mode of the information output device based on the sharing manner; and

sending the shared data to the information output device to display based on the display mode.

In some embodiments of the data sharing method according to the present disclosure, the associated device may comprise one primary associated device and at least one secondary associated device.

In some embodiments of the data sharing method according to the present disclosure, the sharing manner may comprise a first sharing manner and a second sharing manner.

In some embodiments of the data sharing method according to the present disclosure, the display mode may comprise a care mode and an art mode.

In some embodiments of the data sharing method according to the present disclosure, the information output device comprises at least a first information output sub-device and a second information output sub-device for displaying the shared data in the care mode and the art mode, respectively.

In some embodiments of the data sharing method according to the present disclosure, the step of establishing the association relationship between the information output device and the associated device comprises:

receiving an association request for the information output device sent by the associated device;

querying whether the information output device has a primary associated device, in response to the association request; and

determining the associated device to be the primary associated device, in response to there being no primary associated device.

In some embodiments of the data sharing method according to the present disclosure, the step of establishing the association relationship between the information output device and the associated device further comprises:

forwarding the association request of the associated device to the primary associated device, in response to there being the primary associated device;

receiving feedback from the primary associated device regarding the association request to confirm whether the primary associated device agrees to the association request; and

determining the associated device to be the secondary associated device, in response to the primary associated device agreeing to the association request.

In some embodiments of the data sharing method according to the present disclosure, the step of establishing the association relationship between the information output device and the associated device comprises:

receiving an association request sent by the primary associated device for inviting the associated device to establish an association relationship with the information output device;

forwarding the association request to the associated device; and

receiving a confirmation message that the associated device agrees to associate and determining the associated device to be the secondary associated device.

In some embodiments of the data sharing method according to the present disclosure, the step of determining the display mode of the information output device based on the sharing manner comprises:

determining the display mode to be the care mode, in response to the sharing manner being the first sharing manner; and

determining the display mode to be the art mode, in response to the sharing manner being the second sharing manner.

In some embodiments of the data sharing method according to the present disclosure, the step of sending the shared data to the information output device to display based on the display mode comprises:

sending the shared data sent by the associated device in a specified time period automatically to the information output device based on the first sharing manner, in response to the display mode being the care mode; and

sending the shared data sent by the associated device sequentially to the information output device in chronological order in which the associated devices establish the association relationships based on the second sharing manner, in response to the display mode being the art mode.

In some embodiments of the data sharing method according to the present disclosure, the associated device may comprise a mobile communication device or a smart wearable device, and the information output device may comprise a display device or an audio output device.

In some embodiments of the data sharing method according to the present disclosure, the display device may comprise an electronic photo frame or an art picture frame.

In some embodiments of the data sharing method according to the present disclosure, the shared data may comprise one or more of image data, sound data, location data of a user, physiological sign data of a user, exercise data of a user, and sleep data of a user.

According to another exemplary embodiment of the present disclosure, a data sharing device is provided, comprising:

an establishing means, configured to establish an association relationship between an information output device and an associated device;

a receiving means, configured to receive shared data and a sharing manner sent by the associated device;

a determining means, configured to determine a display mode of the information output device based on the sharing manner; and

a sending means, configured to send the shared data to the information output device to display based on the display mode.

According to yet another exemplary embodiment of the present disclosure, a computer readable storage medium is provided, having stored thereon a computer program that, when executed, implements the data sharing method according to some embodiments of the present disclosure.

According to still another exemplary embodiment of the present disclosure, a data sharing system is provided, comprising: a data sharing device and an information output device and an associated device communicatively connected to the data sharing device respectively, wherein

the associated device is configured to send shared data and a sharing manner to the data sharing device;

the data sharing device is configured to establish an association relationship between the information output device and the associated device, receive the shared data and the sharing manner sent by the associated device, determine a display mode based on the sharing manner, and send the shared data to the information output device based on the display mode; and

the information output device is configured to receive the shared data from the data sharing device and display the shared data.

### BRIEF DESCRIPTION OF THE DRAWINGS

In order to more clearly illustrate the technical solutions in embodiments of the disclosure, the appended drawings needed to be used in the description of the embodiments will be introduced briefly in the following. Obviously, the drawings in the following description are only some embodiments of the disclosure, and for those skilled in the art, other drawings can be obtained according to these drawings under the premise of not paying out creative work.

FIG. 1 schematically shows a flow chart of a data sharing method according to some embodiments of the present disclosure;

FIG. 2 schematically shows a structural diagram of an association relationship between an information output device and an associated device established in a data sharing method according to some embodiments of the present disclosure;

FIG. 3 schematically shows a flow chart for establishing an association relationship in a data sharing method according to some embodiments of the present disclosure;

FIG. 4 schematically shows a flow chart for establishing an association relationship in a data sharing method according to some embodiments of the present disclosure;

FIG. 5 schematically shows a structural block diagram of a data sharing device according to some embodiments of the present disclosure; and

FIG. 6 schematically shows a structural diagram of a data sharing system according to some embodiments of the present disclosure.

### DETAILED DESCRIPTION OF THE DISCLOSURE

In order to enable those skilled in the art to understand the present disclosure better, the technical solutions in the embodiments of the present disclosure will be clearly and completely described in the following, in conjunction with the embodiments of the present disclosure and the accompanying drawings.

In the processes described in the description, the claims and the above-described drawings of the present disclosure, a plurality of operations in a particular order are comprised, but it should be clearly understood that these operations may not be performed in the order in which they appear in the disclosure or may be performed in parallel. The serial number of the operation, such as S11, S12, is only used to distinguish different operations, and the serial number itself does not represent any execution order. Additionally, these processes may comprise more or fewer operations, and these operations may be performed sequentially or in parallel. It should be noted that the descriptions of “first” and “second” herein are used to distinguish different messages, devices, modules, etc., and do not represent the order. And the descriptions of “first” and “second” do not define different types.

Those of ordinary skill in the art will understand that unless specifically stated otherwise, terms in singular forms (such as “a”, “an”, “the” and “this”, etc.) are intended to comprise the same terms in plural as well. It is to be further understood that the phrase “comprise” used in the specification of the present disclosure indicates the existence of features, integers, steps, operations, elements, and/or components, but does not exclude the presence or addition of one or more other features, integers, steps, operations, elements, components and/or group thereof. It will be understood that when an element is referred to as being “connected” or “coupled” to another element, it can be directly connected or coupled to the other element, or it may be connected or coupled indirectly through an intermediary. Further, “connection” or “coupling” as used herein may comprise either a wireless connection or a wireless coupling. The phrase “and/or” used herein comprises all or any one and all combinations of one or more of the listed items.

Those of ordinary skill in the art will appreciate that all terms (comprising technical and scientific terms) used herein have the same meaning as commonly understood by one of ordinary skill in the art to which this disclosure belongs, unless otherwise defined. It should also be understood that terms such as those defined in a general dictionary should be understood to have meanings consistent with the meanings in the context of the prior art, and will not be explained in idealized or excessively formal meanings, unless specifically defined herein.

In the following detailed description of the present disclosure, the same or similar reference numerals indicate the same or similar elements or elements having the same or similar functions throughout. Obviously, the described embodiments are only part of the embodiments of the disclosure, and not all of the embodiments. Based on the embodiments in the disclosure, all other embodiments obtained by those of ordinary skill in the art under the premise of not paying out creative work pertain to the protection scope of the disclosure.

FIG. 1 shows a flow chart of a data sharing method according to some embodiments of the present disclosure. The method can be performed with a data sharing device for enabling data sharing between associated terminals associated with a display device, the data sharing device may comprise a computing device with capabilities of information transceiving and data analysis processing, such as a conventional server or a cloud server. As shown in FIG. 1, the data sharing method comprises steps S11-S13, and the steps are described in detail below.

Step S11 depicts establishing an association relationship between an information output device and a device to be associated.

In some embodiments according to the present disclosure, the information output device may comprise display devices, such as digital photo frames, electronic art picture frames, or voice play devices such as speakers and audios; the devices to be associated may comprise mobile communication terminals such as mobile phones, or smart wearable devices such as smart watches.

In some embodiments according to the present disclosure, the data sharing device establishes an association relationship between the device to be associated and the information output device by receiving an association request sent by the device to be associated. Once the association is established, the device to be associated becomes the associated device.

In some embodiments according to the present disclosure, the associated device comprises at least one primary associated device as an owner of the information output device. Alternatively, the associated device may also comprise at least one secondary associated device as a sharer of the information output device. The primary associated device may be the device that first associates with the information output device, or may be specified by the user of the information output device. Other associated devices other than the primary associated device are secondary associated devices.

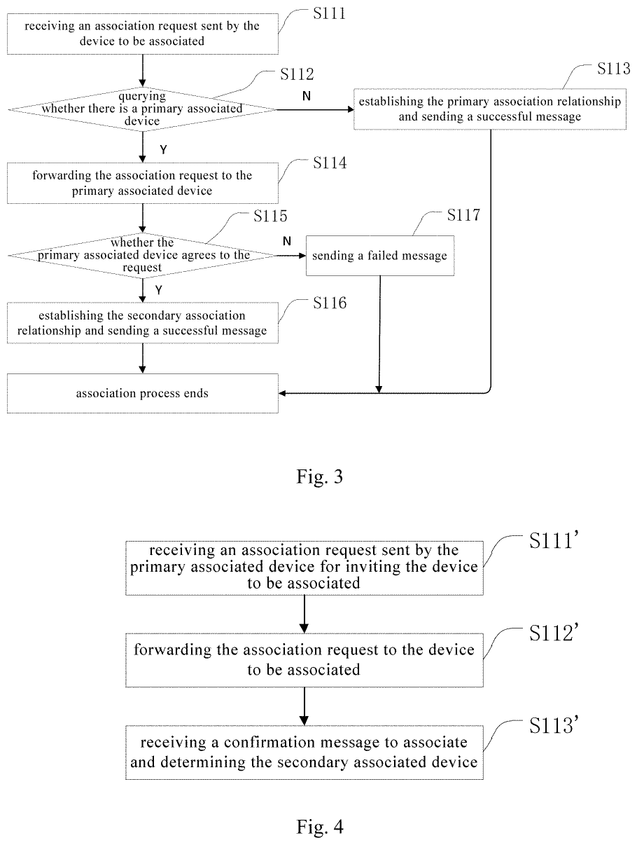

After the primary associated device has been associated with the information output device, other devices to be associated can apply to the data sharing device to establish an association relationship with the information output device. In this case, a device to be associated can establish an association relationship with the information output device after the consent of the primary associated device, then the device to be associated become a secondary associated device. In addition, the primary associated device may also invite other devices to establish an association relationship with the information output device. For details on how the primary associated device and the secondary associated device respectively associate with the information output device, refer to the detailed description in conjunction with FIG. 3 below.

When the primary associated device is disassociated from the information output device, the secondary associated device is also automatically disassociated from the information output device. After the associated devices have established the association relationship with the information output device, personal identity information outputted by the information output device uploaded by all the associated devices for establishing the association request or authentication may be saved in the data sharing device (such as a cloud server). Except for the primary association device, other secondary associated devices do not have access to the personal identity information, thereby protecting the privacy of the user.

In some embodiments according to the present disclosure, after the association relationship is established, the data sharing device may store the corresponding association relationship in the association relationship database. The association relationship database may comprise: identity information of the associated device, identity information of the information output device, and the association relationship category between the associated device and the information output device, that is, a primary association relationship or a secondary association relationship.

In some embodiments according to the present disclosure, one device to be associated may establish an association relationship with one or more information output devices, and one information output device may also establish an association relationship with one or more devices to be associated.

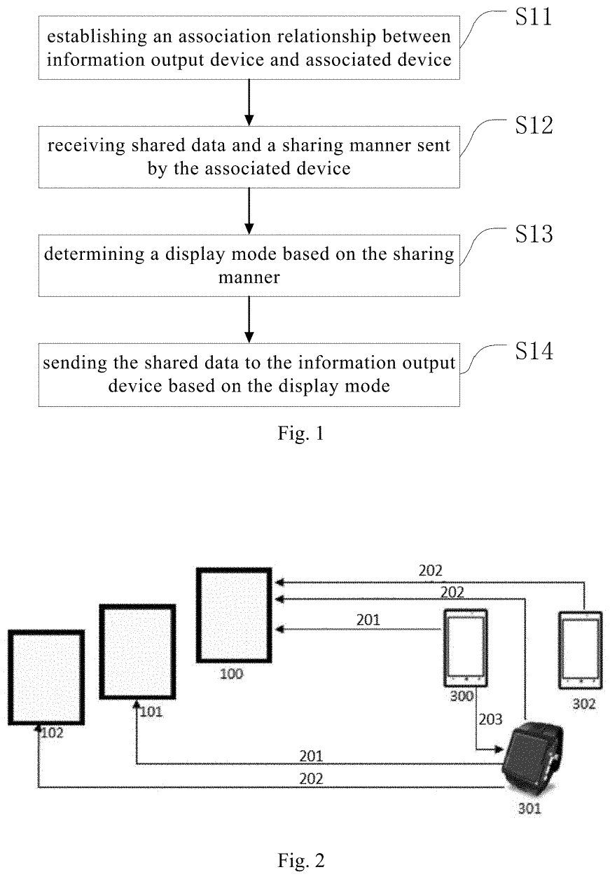

FIG. 2 schematically shows a structural diagram of an association relationship between a plurality of information output devices and a plurality of associated devices. As shown in FIG. 2, information output devices 100-102 and associated devices 300-302 establish a plurality of association relationships through the data sharing device (not shown). The associated devices comprise mobile terminals 300 and 302 and a smart watch 301, the information output devices comprise display devices 100-102. The association relationship established in FIG. 2 is shown in Table 1.

Table 1 association relationship table of FIG. 2

| | information | |
|---|---|---|
| associated device | output device | association relationship |
| 300 | 100 | primary association |
| 301 | 100 | secondary association |
| | 101 | primary association |
| | 102 | secondary association |
| 302 | 100 | secondary association |
| | 102 | primary association |

As shown in FIG. 2 and Table 1, the association relationship shown in FIG. 2 comprises one-to-many (e.g., association of the associated device 301 with the information output device 100-103) or many-to-one (e.g., association of the associated device 300-302 and the information output device 100). Moreover, for each information output device 100-102, there is only one primary associated device; while for each associated device 300-302, it may be a primary associated device, as indicated by arrow 201, or a secondary associated device. For example, the associated device 301 is a secondary associated device, indicated by arrow 202, in the association relationship with the information output device 100, and is a primary associative device, indicated by arrow 201, in the association relationship with the information output device 101. In addition, the primary associated device may also invite other devices to establish an association relationship with the information output device, as indicated by arrow 203.

As shown in FIG. 2, the data sharing method according to the present disclosure enables a flexible sharing scheme of multiple associated devices to one information output device and multiple associated devices to multiple information output devices.

Step S12 depicts receiving shared data and a sharing manner sent by the associated device.

After the associated device and the information output device establish an association relationship, the associated device can upload the shared data to the data sharing device to implement data sharing.

In some embodiments of the present disclosure, the data sharing manner may comprise a first sharing manner and a second sharing manner, where the first sharing manner refers to a private sharing manner, and the second sharing manner refers to a public sharing manner. For example, as described above, a wearable device such as a smart watch of an empty nester as a secondary associated device can upload the captured information about daily life or physical condition parameters of the elderly, e.g., location dynamics, heart rate, exercise status, sleep, etc., to the data sharing device, for presentation to the user of the primary associated device via the information output device. For another example, when the user of the secondary associated device wants to share or display his painting work, the work can be publicly displayed in the information output device such as an electronic frame in the gallery through the data sharing device to realize public sharing of the drawing information.

Step S13 depicts determining a display mode of the information output device based on the sharing manner.

In some embodiments according to the present disclosure, the display mode of the information output device may comprise a care mode and an art mode, which correspond to the first and second sharing manners, respectively. In the care mode, the information output device will automatically display the shared data (e.g., personal related data, such as location dynamics, physiological parameters (heart rate, blood pressure, etc.), exercise status, sleep status, etc.) uploaded by the associated device (comprising the primary associated device or the secondary associated device) within a specified time period (such as one day, one week, one month). In the art mode, the information output device will sequentially display the respective shared data (for example, photographic works, paintings, pictures, etc.) uploaded by each of the associated devices in chronological order in which the associated devices establish the association relationship to display the shared information. Alternatively, the above two display modes can also be freely used in the first or second sharing manner. Of course, the display modes of the information output device are not limited to the above two modes, other display modes may also be adopted, for example, display in a user-specified manner.

Step S14 depicts sending the shared data to the information output device to display based on the display mode.

In some embodiments according to the present disclosure, the data sharing device may send the shared data to the information output device based on the determined display mode to implement the determined display mode. The following describes the implementations of the care mode and the art mode in detail. In the care mode, the data sharing device will automatically send the shared data (e.g., personal related data, such as location dynamics, physiological parameters (heart rate, blood pressure, etc.), exercise status, sleep status, etc.) uploaded by the associated device (comprising the primary associated device or the secondary associated device) within a specified time period (such as one day, one week, one month) to the information output device to display based on the data sharing manner. In the art mode, the data sharing device may sequentially send the respective shared data (for example, photographic works, paintings, pictures, etc.) uploaded by each of the associated devices in chronological order in which the associated devices establish the association relationship to the information output device based on the received data sharing manner to display the shared information.

In some embodiments of the present disclosure, the information output device may also be a group of devices comprising at least a first information output sub-device and a second information output sub-device for displaying shared data in a care mode and an art mode, respectively. For example, the first information output sub-device may be a private display device, such as a private electronic photo frame, for sharing personal information (comprising physical condition, daily life, etc.) to friends and relatives; the second information output sub-device may comprise a public display device, such as an electronic art frame for publicly displaying paintings and calligraphy works. Therefore, after receiving the shared data and the sharing manner thereof, the data sharing device may respectively send the corresponding shared data to the corresponding information output sub-device based on the sharing manner, for example, sending data of the first display mode to the first information output sub-device, and sending data of the second display mode to the second information output sub-device.

In some embodiments according to the present disclosure, the shared data may comprise one or more of image data, sound data, location data of a user, physiological sign data of a user, exercise data of a user, and sleep data of a user. More specifically, the shared data may comprise private information for small-scale analysis, such as personal daily photos or images, physiological parameters, location information, etc.; and information for public display, such as electronic photographs, paintings, film and television works. Of course, the shared data is not limited to the above information, it may comprise any visual or audible information that can be displayed on the display device.

The data sharing method according to some embodiments of the present disclosure solves the problem that the data sharing operation in the prior art is complicated and cumbersome, enables data of multiple mobile terminals to be displayed on one or more devices, and achieves good user experience; and enables a flexible sharing scheme of multiple associated devices to one information output device and multiple associated devices to multiple information output devices.

FIG. 3 shows a flow chart for establishing an association relationship in a data sharing method according to some embodiments of the present disclosure. As shown in FIG. 3, the step S11 shown in FIG. 1, establishing the association relationship between the information output device and the device to be associated, may comprise steps S111-S117, and the respective steps are specifically described below. S111 depicts receiving an association request for the information output device sent by the device to be associated.

Generally, a device to be associated, such as a mobile terminal, may initiate a request to associate or bind with an information output device to a data sharing device, request to share information output rights of the information output device, or share data and information with the information output device. The association request may comprise identity information of the device to be associated and identity information of the information output device. Alternatively, the association request may further comprise the right of information sharing, for example, whether only one of the first sharing manner and the second sharing manner is required, or two sharing manners are required at the same time.

S112 depicts querying whether the information output device has a primary associated device, in response to the association request. If no, go to S113, if yes, go to S114.

After receiving the association request, the data sharing device needs to confirm whether the primary associated device exists, that is, whether the primary association relationship has been established, thus the category of the association relationship (primary association relationship or secondary association relationship) to be established can be determined. For example, the data sharing device can query the established association relationship by the association relationship database stored in the memory thereon. Generally, the primary association relationship is the first established association relationship. If it is queried that there is an established association relationship, it can be concluded that the primary associated device exists. The following steps are divided into two branches. One is the case where there is no primary associated device, that is, the step S113 of establishing the primary association relationship (establishing the first association relationship); the other is the case where the primary associated device exists, that is, the steps S114-S117 of establishing the secondary association relationship.

S113 shows that if there is no primary associated device, the device to be associated is determined to be the primary associated device, and a message that the primary association relationship is successfully established is sent to the primary associated device, and the association process ends.

In some embodiments of the present disclosure, if the data sharing device has not found any association relationship of the information output device, it may be confirmed that the association request is the first association. The device to be associated may be directly regarded as the primary associated device and is informed that the primary association relationship has been established, and the association relationship establishment process ends. Alternatively, the establishment of the primary associated device may also be specified by the user or owner of the information output device. Generally, the user or the owner of the primary associated device and the information output device are usually the same person, so that the user can control the request for data sharing for other device to be associated with the information output device, by the primary associated device binding or associating with the information output device by means of the data sharing device. For example, if a person owns a mobile phone (primary associated device) and an electronic photo frame (information output device), the mobile phone can realize two functions by associating or binding with the electronic photo frame: one is to use the association relationship to display the graphic or sound information in the mobile phone on the electronic photo frame; the other is to use its identity of primary associated device to control requests of association from other devices to be associated (e.g. mobile terminals such as mobile phones and wearable devices).

S114 shows that if the primary associated device exists, forwarding the association request of the device to be associated to the primary associated device.

In some embodiments of the present disclosure, if the data sharing device has found an association relationship of the information output device, especially a primary associated device, it may be confirmed that the current association request is a secondary association relationship request. For the secondary association relationship request, the data sharing device needs to ask the primary associated device whether to agree to the association, that is, the establishment of the secondary association relationship must be confirmed by the primary associated device, which also reflects the dominant role of the primary associated device in all associated devices.

S115 shows that receiving feedback from the primary associated device regarding the association request to confirm whether the primary associated device agrees to the association request. If yes, go to step S116, otherwise go to step S117.

The primary associated device may decide whether to agree to the association request based on the identity information of the device to be associated in the association request. For example, the user of the primary associated device may agree in advance with the user of the device to be associated (e.g., the relatives and friends may associate with each other freely, and others may be associated by paying) to agree to establish an association relationship, and then the primary associated device may store the identity information of the agreed device to be associated. In this way, when receiving the association request, the primary associated device can determine whether to agree to the association request based on identity verification or identity information comparison.

S116 shows that if the primary associated device agrees to the association request, the device to be associated is determined to be the secondary association device, the message that the secondary association relationship is successfully established is sent to the secondary associated device, and the association process ends.

S117 shows that if the primary association device does not agree with the association request, the message that the association is failed is sent to the device to be associated, and the association process ends.

When the data sharing device receives the feedback message of the primary associated device about the association request, it is determined whether to establish a secondary association relationship. If the consent is reached, the device to be associated is determined to be the secondary associated device and the message that the secondary association relationship is successfully established is sent to the secondary associated device, and the association process ends. If the consent is not reached, the message such as “association failed due to failure to authenticate” or “you are not authorized to associate with the information output device” is directly sent, and the association process ends.

Alternatively, in the data sharing method according to some embodiments of the present disclosure, the association relationship with the information output device may also be established by the primary associated device inviting other devices to be associated.

FIG. 4 shows a flow chart for establishing an association relationship in a data sharing method according to some embodiments of the present disclosure. As shown in FIG. 4, the step S11 shown in FIG. 1—establishing the association relationship between the information output device and the device to be associated may comprise the following steps:

S111′ shows that receiving an association request sent by the primary associated device for inviting the device to be associated to establish an association relationship with the information output device;

S112′ shows that forwarding the association request to the device to be associated; and

S113′ shows that receiving a confirmation message that the device to be associated agrees to associate and determining the device to be associated to be the secondary associated device. Then the association process ends.

The disclosure further relates to computer readable storage medium or media having stored thereon a computer program that, when executed on a processor, performs the data sharing method according to some embodiments of the present disclosure as described above.

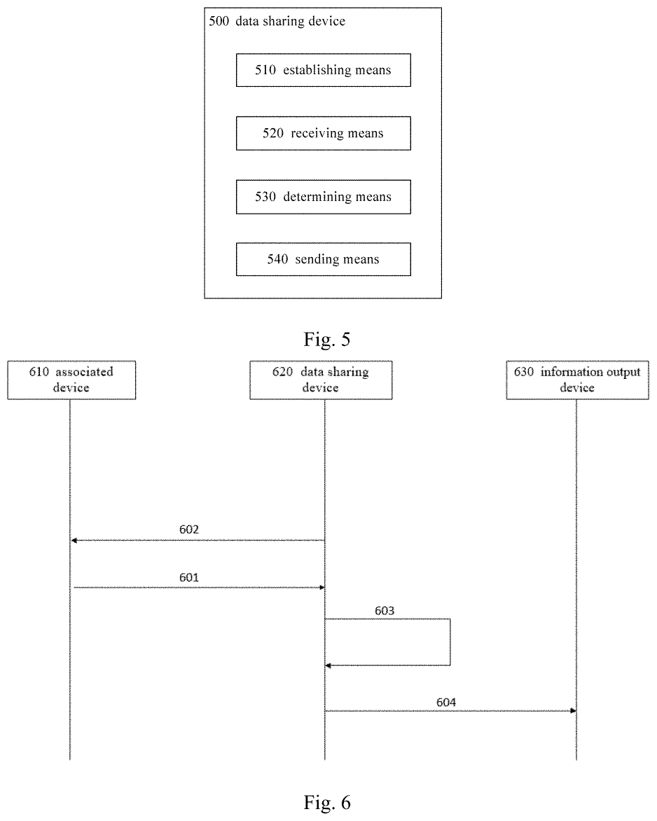

FIG. 5 shows a data sharing device for data sharing according to some embodiments of the present disclosure. As described above, the data sharing method according to some embodiments of the present disclosure can be implemented by a data sharing device similar to that shown in FIG. 5. As shown in FIG. 5, the data sharing device 500 comprises:

an establishing means 510, configured to establish an association relationship between an information output device and an associated device;

a receiving means 520, configured to receive shared data and a sharing manner sent by the associated device;

a determining means 530, configured to determine a display mode of the information output device based on the sharing manner; and

a sending means 540, configured to send the shared data to the information output device to display based on the display mode.

Accordingly, the present disclosure also provides a computer readable storage medium having stored thereon a computer program that, when executed, implements the steps of the data sharing method according to some embodiments of the present disclosure.

FIG. 6 schematically shows a structural diagram of a data sharing system according to some embodiments of the present disclosure. As shown in FIG. 6, the data sharing system according to some embodiments of the present disclosure comprises a data sharing device 620 and an information output device 630 and an associated device 610 communicatively connected to the data sharing device 620 respectively, wherein

the associated device 610 is configured to send shared data and a sharing manner to the data sharing device, as indicated by arrow 601;

the data sharing device 620 is configured to establish an association relationship between the information output device 630 and the associated device 610 as indicated by arrow 602, receive the shared data and the sharing manner sent by the associated device 610, determine a display mode based on the sharing manner as indicated by arrow 603, and send the shared data to the information output device 630 based on the display mode as indicated by arrow 604; and

the information output device 630 is configured to receive the shared data from the data sharing device 620 and display the shared data.

The data sharing system according to some embodiments of the present disclosure shown in FIG. 6 may be used to implement the data sharing method according to the present disclosure as described above. As shown in FIG. 6, the workflow of the data sharing system is as follows:

firstly, the data sharing device 620 establishes an association relationship between the associated device 610 and the information output device 630 based on a request or a requirement, as indicated by arrow 602;

subsequently, the associated device 610 sends the shared data and the sharing manner to the data sharing device, as indicated by arrow 601;

next, the data sharing device 620 determines the display mode of the information output device 630 based on the sharing manner, as indicated by arrow 603;

finally, the data sharing device 620 sends the shared data to the information output device 630 based on the display mode to implement the shared presentation as indicated by arrow 604.

In the description of the present specification, the descriptions of the terms “one embodiment”, “some embodiments”, “example”, “specific example”, or “some examples” and the like mean the specific features, structures, materials or characteristics described in connection with the embodiment or the example are comprised in at least one embodiment or example of the present disclosure. In the present specification, the schematic reference of the above terms is not necessarily directed to the same embodiment or example. Furthermore, the particular features, structures, materials, or characteristics described may be combined in a suitable manner in any one or more embodiments or examples. In addition, those skilled in the art can combine the different embodiments or examples described in this specification and features of different embodiments or examples without conflicting with each other.

Any process or method description in the flowcharts or otherwise described herein may be understood to represent a module, segment or portion of code comprising one or more executable instructions for implementing the steps of a custom logic function or process. And the scope of the preferred embodiments of the present disclosure comprises additional implementations in which the functions may not be performed in an order shown or discussed, comprising in a substantially simultaneous manner or in the reverse order, depending on the function involved, which will be understood by those skilled in the art to which the embodiments of the present disclosure pertain.

The logic and/or steps represented in the flowchart or otherwise described herein, for example, an ordered list of executable instructions which may be considered to implement logical functions, may be embodied in any computer readable medium to be used by or in conjunction with an instruction execution system, apparatus, or device, e.g., a computer-based system, a system comprising a processor, or other system that can fetch instructions and execute instructions from an instruction execution system, apparatus, or device. In terms of this specification, a “computer-readable medium” can be any apparatus that can contain, store, communicate, propagate, or transport a program for use by or in conjunction with an instruction execution system, apparatus, or device. More specific examples of the computer readable medium may comprise, for example, an electrical connection (electronic device) having one or more wires, a portable computer disk (magnetic device), a random access memory, a read only memory, an erasable programmable read only memory or flash memory, an optic fiber device, and a compact disc read only memory. In addition, the computer readable medium may even be a paper or other suitable medium on which the program can be printed, as the program may be electronically obtained by optically scanning paper or other medium, for example, followed by editing, compiling or processing in other suitable manner, if appropriate, and then the program are stored in computer memory.

It should be understood that portions of the present disclosure can be implemented in hardware, software, firmware, or a combination thereof. In the above-described embodiments, multiple steps or methods may be implemented in software or firmware stored in a memory and executed by a suitable instruction execution system. For example, if implemented in hardware, it can be implemented by any one or combination of the following techniques well known in the art: discrete logic circuit having logic gate circuit for implementing logic functions on data signals, application specific integrated circuit having suitable combination of logic gate circuits, programmable gate array, field programmable gate array, and the like.

One of ordinary skill in the art will appreciate that all or a portion of the steps of the above-described embodiments may be performed by a hardware associated with the program instructions, and the program may be stored in a computer readable storage medium, which, when executed, performs one or a combination of the steps of the method embodiments.

In addition, functional units in various embodiments of the present disclosure may be integrated into one processing module, or may exist physically separately, or two or more units may be integrated into one module. The above integrated modules can be implemented in the form of hardware or in the form of software functional modules. The integrated modules, if implemented in the form of software functional modules and sold or used as stand-alone products, may also be stored in a computer readable storage medium.

It should be noted that, in the claims, the use of the verb “comprising/comprise” and its variants does not exclude the presence of elements or steps not recited in the claims, and the wording “a” or “an” does not exclude a plurality.

While the disclosure has been shown and described with respect to the specific embodiments of the present disclosure, it is apparent to those skilled in the art that several variations and modifications may be made without departing from the disclosure. All such variations and modifications are intended to be comprised within the scope of the claims of the disclosure, as fall within the true spirit and scope of this disclosure.

1. A data sharing method, comprising following steps:
establishing an association relationship between an information output device and an associated device;
receiving shared data and a sharing manner sent by the associated device;
determining a display mode of the information output device based on the sharing manner; and
sending the shared data to the information output device to display based on the display mode.

2. The method of claim 1, wherein the associated device comprises one primary associated device and at least one secondary associated device.

3. The method of claim 1, wherein the sharing manner comprises a first sharing manner and a second sharing manner.

4. The method of claim 3, wherein the display mode comprises a care mode and an art mode.

5. The method of claim 4, wherein the information output device comprises at least a first information output sub-device and a second information output sub-device for displaying the shared data in the care mode and the art mode, respectively.

6. The method of claim 2, wherein the step of establishing the association relationship between the information output device and the associated device comprises:
receiving an association request for the information output device sent by the associated device;
querying whether the information output device has a primary associated device, in response to the association request; and
determining the associated device to be the primary associated device, in response to there being no primary associated device.

7. The method of claim 6, wherein the step of establishing the association relationship between the information output device and the associated device further comprises:
forwarding the association request of the associated device to the primary associated device, in response to there being the primary associated device;
receiving feedback from the primary associated device regarding the association request to confirm whether the primary associated device agrees to the association request; and
determining the associated device to be a secondary associated device, in response to the primary associated device agreeing to the association request.

8. The method of claim 2, wherein the step of establishing the association relationship between the information output device and the associated device comprises:
receiving an association request sent by the primary associated device for inviting the associated device to establish the association relationship with the information output device;
forwarding the association request to the associated device; and
receiving a confirmation message that the associated device agrees to associate and determining the associated device to be a secondary associated device.

9. The method of claim 4, wherein the step of determining the display mode of the information output device based on the sharing manner comprises:
determining the display mode to be the care mode, in response to the sharing manner being the first sharing manner; and
determining the display mode to be the art mode, in response to the sharing manner being the second sharing manner.

10. The method of claim 9, wherein the step of sending the shared data to the information output device to display based on the display mode comprises:
sending the shared data sent by the associated device in a specified time period automatically to the information output device based on the first sharing manner, in response to the display mode being the care mode; and
sending the shared data sent by the associated device sequentially to the information output device in chronological order in which the associated device establishes the association relationship based on the second sharing manner, in response to the display mode being the art mode.

11. The method of claim 1, wherein the associated device comprises a mobile communication device or a smart wearable device, and the information output device comprises a display device or an audio output device.

12. The method of claim 11, wherein the display device comprises an electronic photo frame or an art picture frame.

13. The method of claim 1, wherein the shared data comprises one or more of image data, sound data, location data of a user, physiological sign data of the user, exercise data of the user, and sleep data of the user.

14. A data sharing device, comprising:
an establishing means, configured to establish an association relationship between an information output device and an associated device;
a receiving means, configured to receive shared data and a sharing manner sent by the associated device;
a determining means, configured to determine a display mode of the information output device based on the sharing manner; and
a sending means, configured to send the shared data to the information output device to display based on the display mode.

15. A computer readable storage medium, having stored thereon a computer program that, when executed, implements the data sharing method of claim 1.

16. A data sharing system, comprising a data sharing device and an information output device and an associated device communicatively connected to the data sharing device respectively, wherein
the associated device is configured to send shared data and a sharing manner to the data sharing device;
the data sharing device is configured to establish an association relationship between the information output device and the associated device, receive the shared data and the sharing manner sent by the associated device, determine a display mode based on the sharing manner, and send the shared data to the information output device based on the display mode; and
the information output device is configured to receive the shared data from the data sharing device and display the shared data.
